(19) United States
(12) Patent Application Publication
(10) Pub. No.: US 2013/0145243 A1
(43) Pub. Date: Jun. 6, 2013

(54) TASK MANAGEMENT SYSTEM AND METHOD

(71) Applicants: Qian Huang, NEW TAIPEI CITY (TW); Li-Juan Xu, NEW TAIPEI CITY (TW)

(72) Inventors: Qian Huang, NEW TAIPEI CITY (TW); Li-Juan Xu, NEW TAIPEI CITY (TW)

(73) Assignee: WISTRON CORPORATION, New Taipei City (TW)

(21) Appl. No.: 13/433,740

(22) Filed: Mar. 29, 2012

(30) Foreign Application Priority Data
Dec. 2, 2011 (CN) 201110397398.3

(51) Int. Cl. G06F 17/00

(52) U.S. Cl. 715/209

(57) ABSTRACT

A task management system including a monitor and a processing unit is provided. The monitor is for displaying a task schedule, which sequentially tabulates multiple time spots and multiple corresponding tasks. The processing unit is for operating an object at a to-be-executed time spot when the object is dragged to the to-be-executed time spot of the task schedule.

This application claims the benefit of People's Republic of China application Serial No. 201110397398.3, filed Dec. 2, 2011, the subject matter of which is incorporated herein by reference.

### BACKGROUND OF THE INVENTION

1. Field of the Invention

The invention relates to a task management system and method.

2. Description of the Related Art

As various application programs continue to develop and evolve, a current operations system is able to offer a task management system for a user to manage routine tasks and sporadic tasks. However, a market-available task management system only allows rigid task management functions rather than providing a user with intuitive operations and flexible settings.

### SUMMARY OF THE INVENTION

The invention is directed to a task management system and method for offering a user with more intuitive and convenient operations.

According to an aspect of the present invention, a task management system including a monitor and a processing unit is provided. The monitor displays a task schedule, which sequentially tabulates multiple time spots and multiple corresponding tasks. The processing unit operates an object at a to-be-executed time spot when the object is dragged to the to-be-executed time spot in the task schedule.

According to another aspect of the present invention, a task management method is provided. The method includes steps of: displaying a task schedule by a monitor, the task schedule sequentially tabulating multiple time spots and multiple corresponding tasks; dragging an object to a to-be-executed time spot in the task schedule, and operating the object at the to-be-executed time spot by a processing unit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a task management system according to an embodiment of the present invention.

FIG. 2 is a schematic diagram of a task management method according to an embodiment of the present invention.

FIGS. 3 to 7 are schematic diagrams of operations of a task management method according to an embodiment of the present invention.

### DETAILED DESCRIPTION OF THE INVENTION

A task management system and method is disclosed to provide a user with enhanced operation conveniences through intuitive operations.

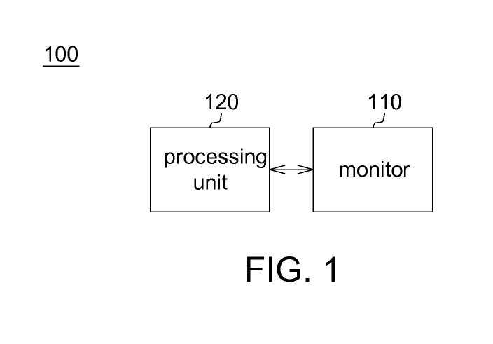

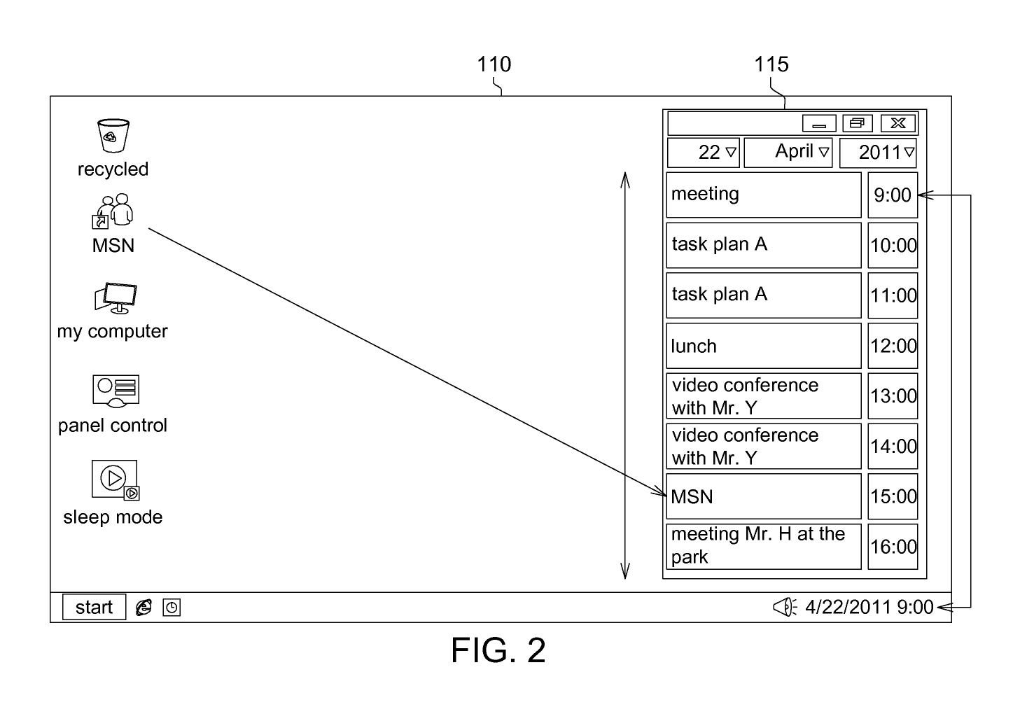

Referring to FIGS. 1 and 2, FIG. 1 shows a block diagram of a task management system according to an embodiment of the present invention, and FIG. 2 shows a schematic diagram of a task management method according to an embodiment of the present invention. A task management system 100 includes a monitor 110 and a processing unit 120. As shown in FIG. 1, the monitor 110 displays a task schedule 115, which sequentially tabulates multiple time spots and multiple corresponding tasks. All tasks in the task schedule 115 may be checked by scrolling a mouse up and down.

A user may drag an object to a to-be-executed time spot in the task schedule 115, e.g., a time point (15:00) in FIG. 1. Thus, the task management system 100 regards the object as a task to be executed at the to-be-executed time point. For example, the object is an application procedure or a document. The processing unit 120 then automatically performs the object at the to-be-executed time point. That is, at the time point (15:00), the processing unit 120 automatically executes the application procedure or automatically opens or executes the document.

In this embodiment, the processing unit 120 in real-time updates the task schedule 115, and places a current time point and a corresponding task at the top of the task schedule 115. More specifically, the processing unit 120 compares a current time point of the system with multiple time points in the task schedule 115, and selects and displays a time point in the task schedule 115 having a smallest difference with the current time of the system and a time point in the task schedule 115 smaller than a threshold along with the corresponding task at the top. Referring to FIG. 1, corresponding to the current time (9:00), the task schedule 115 places the current time point (9:00) and the corresponding task (meeting) on the top. Thus, a user intuitively and immediately learns the to-be-executed task for the current time point, rather than having to scroll up and down to find the to-be-executed task for the current time point as in a conventional task schedule.

Further, a user may define a setting for the task management system 100. For example, a user may set the task schedule such that at a time point before the current time point, e.g., three minutes before the current time point, the monitor 110 displays a reminder window to remind the user of a to-be-executed task.

To keep a desktop of the monitor 110 clean and tidy, the task schedule 115 may be set to be hidden when not in use. The monitor 110 only displays the task schedule 115 when a predetermined event is triggered. For example, the task schedule 115 may be hidden to a right side of an image displayed by the monitor 110, and the monitor 110 only displays the schedule 115 when a user moves a mouse near a right edge of the monitor 110.

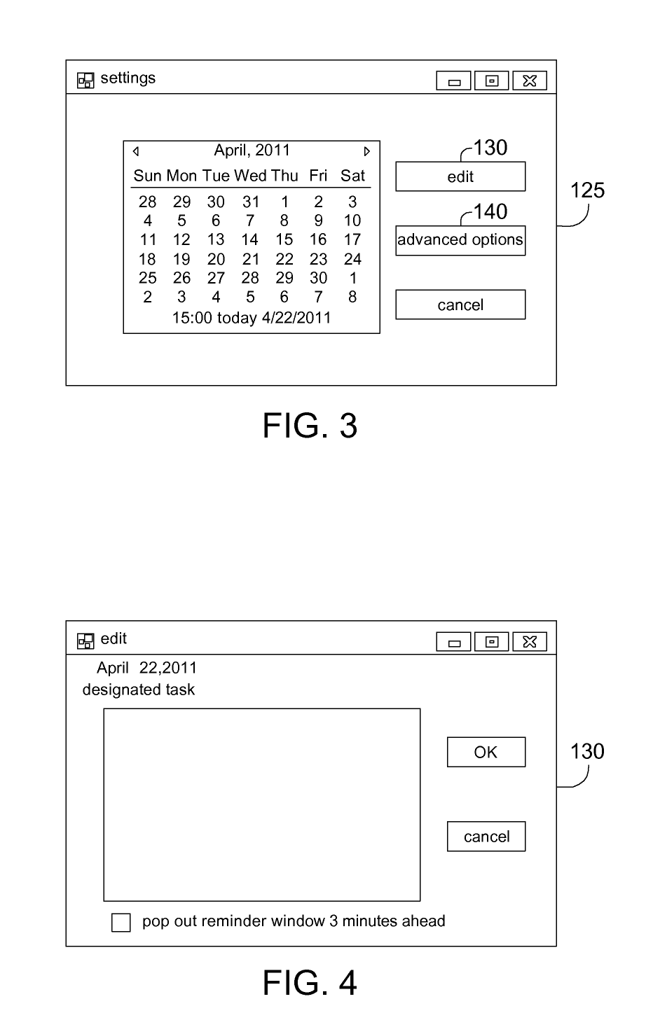

Apart from providing the above intuitive, simple methods for task management, the task schedule of the embodiment also offers more detailed and sophisticated settings. FIGS. 3 to 7 are schematic diagrams of operations of a task management method according to an embodiment. A setting window 125 for the task schedule 115 may be called out by right-clicking a mouse. Referring to FIG. 3, in the setting window 125, a user may set a to-be-execute time point of a designated task. Next, by clicking an edit page 130 in the setting window 125, content of the designated task may be edited in a text frame of the edit page 130 as shown in FIG. 4. In the edit page 130, a reminder window may also be optionally selected.

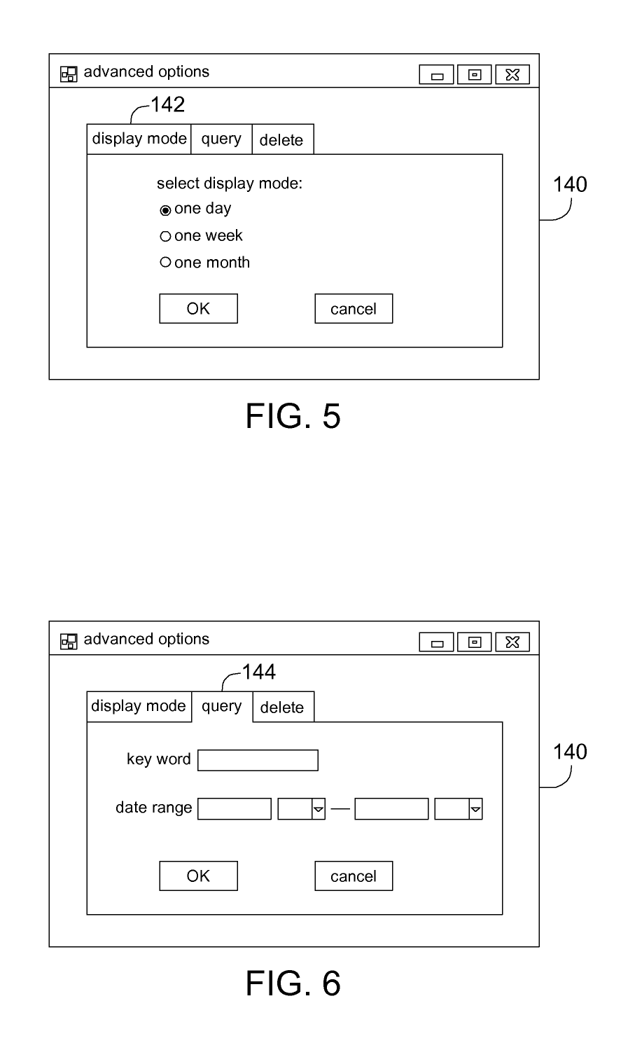

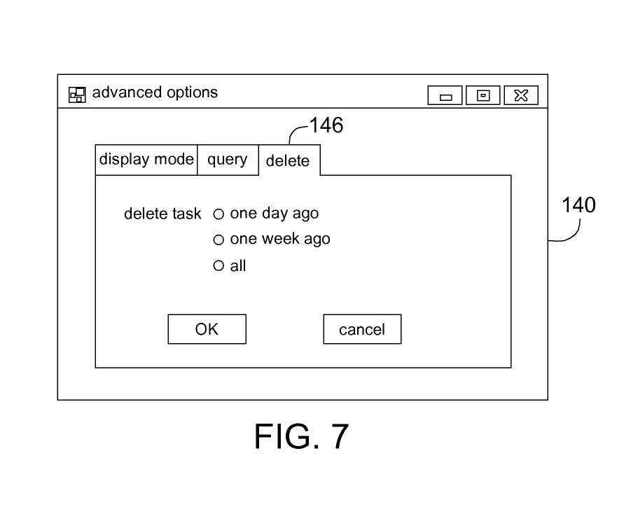

A user is allowed with more detailed settings by clicking an advanced option page 140 in the setting window 125. In FIG. 5, in a display mode sub-page 142 in the advanced option page 140, a display mode of the task schedule 115 may be set, e.g., the task schedule 115 may be set to different time durations. In FIG. 6, in a query sub-page in the advanced option page 140, a query for multiple tasks in the task schedule 115 may be inputted according to key words or a date range. In FIG. 7, in a delete sub-page 144 in the advanced option page 140, expired tasks may be deleted.

With the task management system and method as disclosed above, a user is provided with more enhanced operation conveniences and more complete function options through intuitive operations and detailed option settings.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A task management system, comprising:
a monitor, for displaying a task schedule, the task schedule sequentially tabulating a plurality of time points and a plurality of corresponding tasks; and
a processing unit, for performing an object at a to-be-executed time point when the object is dragged to the to-be-executed time point in the task schedule.

2. The task management system according to claim 1, wherein the object is an application procedure or a document.

3. The task management system according to claim 1, wherein the task schedule updates in real-time to display a current time point and the corresponding task at a top of the task schedule.

4. The task management system according to claim 3, wherein the monitor displays a reminder window at a time point ahead of the current time point.

5. The task management system according to claim 3, wherein the task schedule is hidden, and the monitor displays the task schedule when a predetermined event is triggered.

6. The task management system according to claim 3, wherein the task schedule provides a setting window for querying the tasks, deleting expired tasks or setting a display mode of the task schedule.

7. A task management method, comprising:
displaying a task schedule by a monitor, the task schedule sequentially tabulating a plurality of time points and a plurality of corresponding tasks; and
dragging an object to a to-be-execute time point in the task schedule, and operating the object at the to-be-executed time point by a processing unit.

8. The task management method according to claim 7, further comprising:
updating in real-time by the processing unit to display a current time point and the corresponding task at a top of the task schedule.

9. The task management method according to claim 8, further comprising:
displaying a reminder window at a time point ahead of the current time point by the monitor.

10. The task management method according to claim 8, further comprising:
hiding the task schedule; and
displaying the task schedule by the monitor when a predetermined event is triggered.

11. The task management method according to claim 8, further comprising:
providing a setting window for the task schedule by the monitor to set a to-be-executed time point of a designated task;
editing content of the designated task through an edit page of the setting window; and
setting a display mode of the task schedule, querying the tasks or deleting expired tasks through an advanced option page of the setting window.
